(19) United States
(12) Patent Application Publication
(10) Pub. No.: US 2018/0033056 A1
(43) Pub. Date: Feb. 1, 2018

(54) COMPETITOR TREND-BASED SOCIAL CONTENT IDEATION

(71) Applicant: ADOBE SYSTEMS INCORPORATED, San Jose, CA (US)

(72) Inventor: Jonathan LANCAR, Fremont, CA (US)

(21) Appl. No.: 15/224,752

(22) Filed: Aug. 1, 2016

(51) Int. Cl. G06Q 30/02; G06Q 50/00

(52) U.S. Cl. CPC G06Q 30/0277; G06Q 50/01

(57) ABSTRACT

Systems and methods provide for generating publication pitches based on social trends identified on social networks. Pieces of social data associated with one or more competitor assets are obtained. The pieces of social data, particularly the engagement data associated therewith, are analyzed to identify one or more social trends. A content query is generated based on the identified social trends, and processed to obtain one or more pieces of relevant content from content-rich data sources. The obtained relevant content, or portions thereof, is utilized to generate one or more publication pitches that are based on the social trends identified on the social networks. Selected publication pitches can then be scheduled for publication on select social networks in accordance with identified social trends.

### BACKGROUND

Social networks have developed into a valuable marketing tool for the consumer goods and services industries. Companies can send communications to their consumer base in a matter of seconds, without regard for fees associated with publication and distribution, in contrast to traditional methods. Even more valuable to the companies, however, is the ability to employ these social networks to obtain engagement data from their customer base in real-time. That is, consumers can receive content that is published to a social network asset associated with a company or brand, and provide feedback regarding their comments and opinions to the published content. Typically, this engagement data is publicly available, so that the company, consumers, and even the company's competitors can view the information.

Companies are continuously trying to improve consumer outreach through social networks. Coming up with new ideas for creative content (i.e., content ideation) that is new and engaging can be a challenging task, however. Appealing to the masses can take a tremendous effort from market analysts, brand marketers, graphics designers, and all other collaborators involved in the ideation process. Needless to say, content ideation can prove to be rather time-consuming and costly.

### SUMMARY

Embodiments of the present invention relate to, among other things, facilitating social content ideation based on social trends. Pieces of social data, such as social posts, that are associated with a competitor brand are obtained from one or more social media networks. The obtained pieces of social data are analyzed to identify a social trend. The identified social trend can include contextual information, such as keywords, that clearly identify the subject matter, category, of context of the identified social trend. The contextual information is employed to generate a content query that is processed to obtain content that is relevant to the identified social trend. At least a portion of the obtained content is employed to generate one or more potentially-adoptable ideas, in the form of example social posts or “publication pitches,” which are relevant to the identified social trend and can also be viewed for content ideation. That is, content is retrieved and appropriately assembled to generate, among other things, a publication pitch that is based on the social trend identified from the competitor's social data. In some embodiments, the generated publication pitch can be published to a social network in accordance with the identified social trend.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram illustrating an exemplary system in accordance with some implementations of the present disclosure;

FIG. 2 is a screen display showing an example user interface that provides an indication of popular social trends identified within pieces of social data, relevant/popular keywords within each social trend, and visual data and publication pitches for a selected trend;

FIG. 3 is a flow diagram showing a method for facilitating social content ideation in accordance with implementations of the present disclosure;

FIG. 4 is a flow diagram showing another method for facilitating social content ideation in accordance with implementations of the present disclosure;

FIG. 5 is a flow diagram showing another method for facilitating social content ideation in accordance with implementations of the present disclosure; and

FIG. 6 is a block diagram of an exemplary computing environment suitable for use in implementations of the present disclosure.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various terms are used throughout this description. Definitions of some terms are included below to provide a clearer understanding of the ideas disclosed herein:

As used herein, the term “social data” refers to both published social content and engagement data associated therewith. For instance, published social content can include a media portion (e.g., images, videos, audio, any other electronic media that can be publicly shared by an entity on a network, such as the Internet, or any combination thereof) and/or a text portion (e.g., URLs, captions, quotes, passages, journal entries, etc.). The published social content can include one or more pieces of social content. In some instances, each piece of published social content can also include sub-pieces of social content. For instance, one piece of social content can be equivalent to a “post” to a social network platform. In another instance, a piece of social content can be equivalent to one piece of social content within a set of pieces included in a “post.” Engagement data associated with the published social content can include one or more consumer interactions that correspond to each piece of published social content. Consumer interactions can include comments, opinions, “likes”, “dislikes”, “tweets”, “retweets”, hashtags, usernames, user references, emoticons, ASCII art, images, animations, videos, audio, text, URLs, any other electronic media that can be publicly shared on a network, or any combination thereof, by one or more users. Typically, a set of engagement data, which can include one or more consumer interactions, is associated with a piece of published social content.

The term “competitor asset” refers to a publicly accessible electronic medium, typically in the social media realm, that is associated with a competing entity or brand. The electronic medium can be any one of a social media page, a social media feed, an RSS feed, a newsletter, a webpage, a blog, a landing page, an electronic forum, and the like. Generally, the competitor asset includes the competitor's social data, as described herein above. By way of example only, if a user is an employee of Coca-Cola®, a competitor asset relative to the user can be a Facebook® page or a Twitter® feed for Pepsi®.

The term “social trend” refers to contextual information (e.g., keywords or phrases) associated with one or more popular pieces of published social content that indicate a popular topic, story, or subject, at a given time. A social trend can exist in accordance with comparatively high levels of consumer engagement in social media content of a particular context. A social trend can include keywords and/or other identifiers that identify a subject matter and/or a category of the one or more popular pieces of published social content. The social trend can be identified by determining, based on an analysis of the engagement data associated with at least a portion of a competitor's social data, where one or more pieces of social content have more interactions (i.e., of statistical significance) than other pieces of social content. Various limiting factors, such as a time period, or exclusionary keywords, among other things, can be considered when identifying social trends.

The term “content query” refers to an electronic search for content, such as images, videos, audio, text, URLs, any other electronic media that can be publicly shared by an entity on a network, or any combination thereof, utilizing search parameters provided thereto. A content query can be performed on a local data source, a networked data source, a third-party data source, or any combination of the foregoing. Content retrieved in response to a processed content query can include licensed content and/or unlicensed content.

The term “publication pitch” refers to a piece of social content that is or can be published in whole or in part to a social network. Generally speaking, and in accordance with embodiments described herein, a publication pitch can include a media portion and/or a text portion, and is further based at least in part on identified social trends.

The term “consumer” is used herein to refer to a visiting user of a competitor asset. Generally speaking, a consumer can be any user or entity that is or is not a fan of a competitor brand. A consumer can interact with one or more pieces of published social content to leave one or more pieces of corresponding engagement data therewith.

The term “user” is used herein to refer to a marketer, publisher, editor, author, or other person who employs the ideation tools described herein to view identified social trends and generated publication pitches that are based on the identified social trends.

Content ideation for digital marketing is just as much of an analytical process as it is a creative one. One aspect of a digital marketer's job is to publish a work that has a high likelihood of mass appeal. Analytics data can be utilized to provide a factor of confidence before social content is published or posted on social media. By way of example only, analytics data on social data may show that every four years, consumer engagement with social posts pertaining to soccer has a tendency to trend for about a month's time between the months of June and July. In this regard, a digital marketer may utilize this information to shape her decision to post soccer-related social content during this time period. While most may understand that such a trend may be attributed to the FIFA World Cup, other trends may not be expected or as obvious.

Embodiments of the present invention relate to a solution that can analyze competitor social media asset(s) to identify social trends based at least in part on consumer engagement therewith. Social data associated with one or more competitor assets can be obtained for analysis. The social data can be analyzed to identify one or more social trend(s) therein. A content query can be generated, based on the identified social trend(s), to obtain content that is relevant to the identified social trend(s). After the relevant content is obtained, one or more publication pitches in accordance with the identified trend(s) can be generated with the obtained relevant content. In other words, one or more social posts that each include relevant content based on the identified trend(s) can be generated. Further embodiments can present the generated publication pitch(es) to a user in a marketing dashboard, such as one that displays characteristics of the identified trend(s). This can allow the user to view trends identified in competitor social data, view publication pitches that were generated based on the trend for content ideation purposes, and in some embodiments, facilitate the adoption of a publication pitch by publishing a selected publication pitch to a social network.

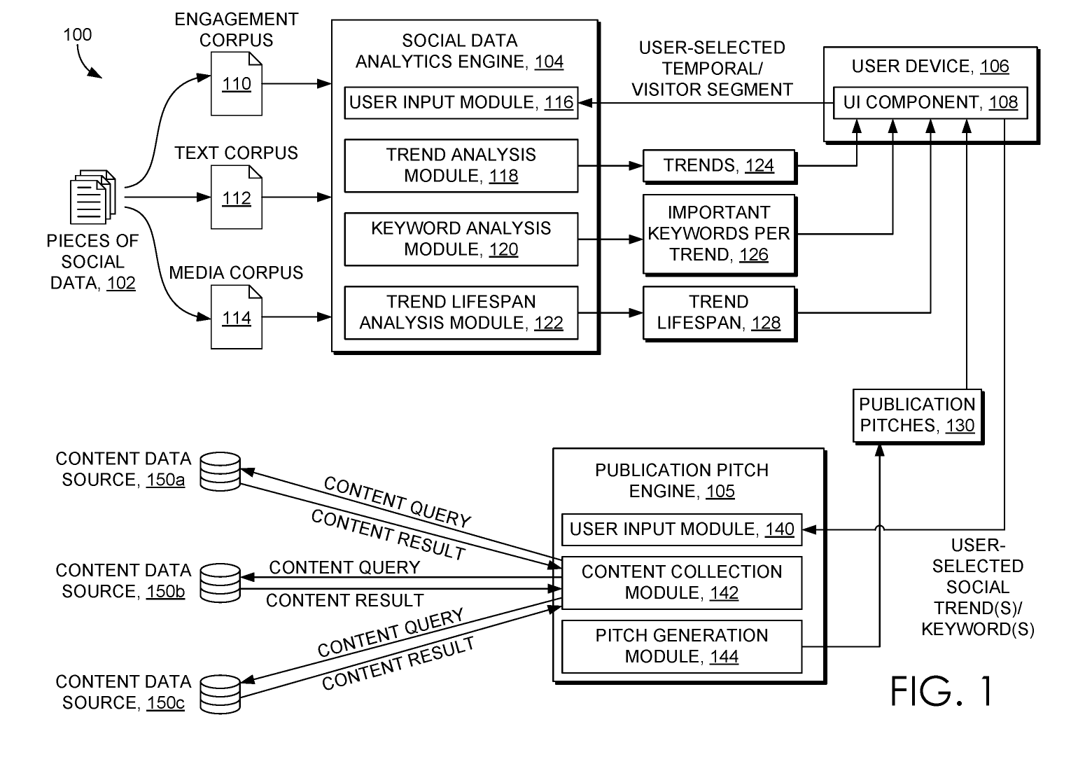

With reference now to the drawings, FIG. 1 is a block diagram illustrating an exemplary system 100 for enabling social content ideation in accordance with some implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The system 100 is an example of a suitable architecture for implementing certain aspects of the present disclosure. Among other components not shown, the system 100 can include a social data analytics engine 104 configured to process pieces of social data 102, which may include social content and engagement data, to provide user interfaces that allow a user to investigate popular trends and keywords from the pieces of social data 102. The system 100 can also include a publication pitch engine 105 configured to generate one or more pieces of social content or “publication pitches” in accordance with the trends and keywords provided by the social data analytics engine 104, utilizing relevant content obtained from one or more data sources. The social data analytics engine 104 can be configured to further provide user interfaces that allow the user to investigate the generated pieces of social content in accordance with identified trends. The social data analytics engine 104 and the publication pitch engine 105 may be provided, for instance, by a social analytics tool, such as the ADOBE SOCIAL tool (available from Adobe Systems Inc. of San Jose, Calif.).

The pieces of social data 102 comprise a collection of social posts that are stored in electronic form on one or more server devices (not shown). In some instances, the pieces of social data 102 includes all available social posts and associated engagement data from a particular competitor asset. For example, the pieces of social data 102 could include all social posts and engagement data published on Adobe Inc.'s Facebook page over a given time period. In other instances, the pieces of social data 102 includes only a subset of social posts and associated engagement data available on a particular competitor asset, or a selection of social posts and associated engagement data from multiple competitor assets. Each piece of social data may correspond to a different competitor asset at which the piece of social data is available.

The engagement corpus 110 is a collection of the engagement data associated with each piece of social data from the pieces of social data 102. The engagement corpus can be collected regarding each piece of social data from the pieces of social data 102, for instance, using a social analytics tool, such as the ADOBE SOCIAL tool. The engagement corpus 110 can include a variety of types of engagement data that may be collected and made available to the social data analytics engine 104. For instance, the engagement data for each piece of social data may include a total number of views, unique visitors, likes, dislikes, emoticons (e.g., happy face, sad face), shares, retweets, comments, hashtags, references, URLs, and the like. The engagement data may also include information regarding each view or unique visitor, such as time stamps when accessed, length of time viewed, and visitor characteristics (e.g., demographics such as gender, age, geolocation, etc.).

The text corpus 112 is a collection of the text portion of each piece of social data from the pieces of the social data 102. In some configurations, the text portion of each piece of social data is retrieved using a parser to access the URL associated with the competitor asset and download raw text from the competitor asset. The parser can download the raw text so that associations with particular social posts can be conserved (e.g., timestamps associated with each text portion). In some other configurations, the text portion of each piece of social data is retrieved using a web crawler to access the URL associated with each piece of social data and download raw text from each URL. The retrieved raw text portion is then stored in the text corpus 112.

The media corpus 114 is a collection of the media portion of each piece of social data from the pieces of social data 102. In some configurations, the media portion of each piece of social data is retrieved using a parser to access the URL associated with the competitor asset and download raw media files from the competitor asset. The parser can download the raw media so that associations with particular social posts can be conserved (e.g., timestamps associated with each media portion). In some other configurations, the media portion of each piece of social data is retrieved using a web crawler to access the URL associated with each piece of social data and download raw media files from each URL. The retrieved raw media portion is then stored in the media corpus 114. In some embodiments, the media corpus 114 can include tags, metadata, hashtags, or keywords that are associated with each piece of social data to provide some context to each media portion in the corpus 114. In some other embodiments, tags, metadata, hashtags, or keywords can be associated with each media portion in the corpus 114 after being processed by various methods, such as automated comparison of electronic media, contextual image or video analyses, or other machine learning techniques typically employed for extracting contextual information of media.

The social data analytics engine 104 is generally configured to operate on the engagement corpus 110, text corpus 112, media corpus 114, or any combination thereof to provide information to a user about social trends (e.g., popular topics, subjects, categories, terms, keywords, etc.) associated with the pieces of social data 102. In particular, the social data analytics engine 104 analyzes the engagement corpus 110, text corpus 112, media corpus 114, or any combination thereof, to provide an indication of ranked trends 124 and important keywords or categories per trend 126 to a UI component 108 on a user device 108.

For instance, a social trend can be identified for a 24-hour period by determining which pieces of social content attract the higher amounts of consumer engagement when compared to other pieces of social content. In accordance with embodiments described herein, consumer engagement for a piece of social content can be measured based on a total number of unique interactions with the piece of social content, a number of unique users interacting with the piece of social content, a number of views, shares, or references to the piece of social content, a number of likes associated with the piece of social content, or any non-limiting combination thereof.

In another instance, one or more social trend(s) can be identified for a 5-year period by determining which pieces of social content attract the highest amount of consumer engagement when compared to other pieces of social content over the 5-year period. In either instance, the social data can be analyzed to determine whether certain trends have recognizable and/or predictable patterns. By way of example, for every month of February within the 5-year period, a social trend can be identified where consumer engagement is comparatively high for pieces of social content pertaining to home improvement. In this regard, a social trend of “home improvement” in “February” can be identified. In some embodiments, popular keywords associated with the social data corresponding to these identified trends can assist in providing additional contextual understanding. For instance, if the “home improvement” in “February” trend is identified, and a popular keyword or phrase identified (e.g., in the engagement data) is “tax return,” then a social trend indicating that consumer engagement is generally high for home improvement products during tax return season can be determined.

Additionally, the social data analytics engine 104 can analyze the lifespan of trends, keywords, categories, and terms for the pieces of social data 102 and trend lifespans 128 can be provided to the user device 106 for display via the UI component 108. The information may be presented via the UI component 108 using any number of user interfaces that allow a user to explore the information. The UI component 108 is a web browser or other application on the user device 106 that operates to display user interfaces providing information regarding popular trends, categories, keywords, and terms from the pieces of social data 102.

In some configurations, the user may employ the UI component 108 to select a particular temporal period to analyze. As shown in FIG. 1, information regarding a user-selected time period may be received by the social data analytics engine 104 via a user input module 116. The information may include temporal factors, such as, for instance, a time period, a particular year, month, week, day, hour, minute, second, season, quarter, holiday, or any combination thereof. By allowing the user to specify a particular time period, the social data analytics engine 104 identifies social trends in that time period. For instance, a user may wish to identify social trends within the pieces of social data 102 between May 2010-May 2016.

In some further configurations, the user may employ the UI component 108 to select a particular visitor segment to analyze. As shown in FIG. 1, information regarding a user-selected visitor segment may be received by the social data analytics engine 104 via a user input module 116. The information may include visitor characteristics, such as, for instance, age, gender, interests, and/or geolocation. By allowing the user to specify a particular visitor segment, the social data analytics engine 104 identifies social trends that are popular to that visitor segment. For instance, a user may wish to analyze social trends within the pieces of social data 102 that are popular to females, aged 25-40.

While the social data analytics engine 104 is shown separate from the user device 106, it should be understood that the social data analytics engine 104 may be provided on the user device 106 in some configurations or the social data analytics engine 104 may be provided remote from the user device 106 in other configurations (e.g., provided on a remote server). If the social data analytics engine 104 is remote from the user device 106, the social data analytics engine 104 and user device 106 communicate over a network (not shown), which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present invention. Each may comprise a single device or multiple devices cooperating in a distributed environment. For instance, the social data analytics engine 104 may be provided via multiple devices arranged in a distributed environment that collectively provide the functionality described herein. Additionally, other components not shown may also be included within the system 100.

The social data analytics engine 104 can include a number of modules that process information regarding the pieces of social data 102 to identify social trends, categories, keywords, and/or terms and identify trend lifespans, including a trend analysis module 118, keyword analysis module 120, and trend lifespan analysis module 122. In some configurations, machine learning processes can be employed to process the information regarding the pieces of social data 102 to identify the same.

The trend analysis module 118 can identify social trends for the pieces of social data 102. The trend analysis module 118 can analyze the media portion, the text portion, the engagement portion, or any combination thereof, of each piece of social data (stored in the media corpus 114, the text corpus 112, and the engagement corpus 110, respectively) to identify social trends and generates relevance scores indicating the relevance of each social trend to each piece of social data. Social trend scores are then generated for each social trend and each piece of social data as a function of the relevance score of each social trend and engagement metrics (derived from engagement data stored in the engagement corpus 110) for each piece of social data.

In instances where the user has specified a particular temporal factor, the time period for the analyzed pieces of social data correspond to that time period. For example, suppose the user has specified a time period of May 2010 to May 2015. In that case, the time period used would be pieces of social data (e.g., social posts and associated engagement data) published between May 2010 and May 2015. An aggregated trend score can be computed for each trend identified between this period by summing the social trend scores for each trend identified in the pieces of social data. A set of ranked trends 124 can then be provided based on the aggregated trend scores. An indication of the ranked trends 124 can be provided to the UI component 108 on the user device 106 for display to the user.

In instances where the user has specified a particular visitor segment, the visitor metrics used correspond to that visitor segment. For example, suppose the user has specified a visitor segment corresponding to females, age 25-40. In that case, the pieces of social data used would be those where consumer engagement (e.g., page views, unique visitors, interactions, etc.) included consumers who are female, aged 25-40. Similar to the above, an aggregated trend score can be computed for each trend identified for the particular visitor segment by summing the social trend scores for each trend identified in the pieces of social data. A set of ranked trends 124 can then be provided based on the aggregated trend scores. An indication of the ranked trends 124 can be provided to the UI component 108 on the user device 106 for display to the user.

The keyword analysis module 120 can identify important keywords for trends identified from the pieces of social data 102. Generally, important keywords are identified for a given trend by first computing keyword scores for keywords found in each piece of social data. A keyword score is computed for a given keyword and piece of social data as a function of the keyword frequency of the keyword in the piece of social data and/or engagement data associated therewith, and a score representing the relevance of the given trend to the piece of social data and/or the popularity of the piece of social data as determinable by the associated engagement data. An aggregated keyword score is computed for each keyword by summing the keyword scores for each keyword from the various pieces of social data. The aggregated keyword scores for the keywords are used to rank the keywords for the given trend and an indication of the important keywords for each trend 126 can be provided to the UI component 108 on the user device 106 for display to the user.

The trend lifespan analysis module 122 can analyze the lifespan of social trends among the pieces of social data 102. This allows a user to explore how particular trends have risen and fallen in popularity over time. Generally, a lifespan for a given trend is determined by computing social trend scores and/or keyword scores, respectively, over time intervals (e.g., hourly, daily, weekly, etc.) for each piece of social data representing the relevance and popularity of the trend or keyword for the piece of social data for each time interval. The social trend scores for the various pieces of social data are zero-centered in time to take into account that different pieces of social data are published at different times. Aggregated trend scores are then generated for each time interval by summing the trend scores from each piece of social data for each time interval. As such, the aggregated trend scores represent the social trend lifespan by indicating the relevance and popularity of the social trend over the time intervals. An indication of the trend lifespan 128 can be provided to the UI component 108 on the user device 106 for display to the user.

In some configurations, the social data analytics engine 104 can provide one or more selected or ranked social trends, which can include metadata (e.g., keywords, topics, subjects, categories, or phrases) associated with each identified trend 126, to a publication pitch engine 105 in communication therewith. The publication pitch engine 105 is generally configured to operate on one or more social trends identified (for instance, by social data analytics engine 104) in the pieces of social data 102. In particular, the publication pitch engine 105 can generate and process a content query that is based on the identified social trend(s) to provide one or more publication pitches 130 in accordance with the identified social trend(s) to a UI component 108 on a user device 108.

In some embodiments, a publication pitch can be generated for an identified social trend by obtaining content that corresponds to the identified trend. The content can be obtained by processing a content query that is generated based on an identified social trend. Processing the content query retrieves electronic content (e.g., images, videos, audio, any other electronic media that can be publicly shared by an entity on a network, such as the Internet, or any combination thereof) that corresponds to the identified trend. Electronic content can correspond to an identified trend by having metadata, labels, tags, or other identifying information that substantially map to the metadata associated with the identified trend.

For instance, a publication pitch can be generated for an identified social trend by at least retrieving relevant content that corresponds to the identified social trend. The relevant content can be retrieved by processing a content query that is based on the content of the identified social trend. By way of example only, an identified social trend of “home improvement” and “February” and “tax return” communicated to the publication pitch engine 105 can cause the publication pitch engine 105 to generate a content query that, when processed, can retrieve relevant content from one or more content data sources. The content data sources can be locally or remotely located, and content can be retrieved via various data communication methods (e.g., storage drives, networks, cloud storage, etc.). The content query can comprise any combination of any portion of the identified social trend and its associated keywords.

It is contemplated that machine learning processes can extrapolate relevant search terms associated with an identified social trend and its keywords to generate a more relevant and directed content query to obtain more relevant content results. By way of example, the identified social trend of “home improvement” and “February” and “tax return” can be analyzed by machine learning processes to generate a content query that, when processed, can obtain search results for both a media portion and a content portion for one or more publication pitches. The content query can include search terms relevant to an identified social trend and can include a plurality of relevant search terms that are typically associated with the identified trend and its keywords. For instance, a search result for a media portion of a publication pitch can relate to products (e.g., lawn mowers, gardening tools, gutter systems, etc.) or services (e.g., landscaping, gutter cleaning, etc.) relevant to Spring season home repair or landscaping, in accordance with the previously-noted social trend. Moreover, a search result for a content portion of a publication pitch, including relevant phrases, quotes, comments, opinions, tips, keywords, hashtags, references, URLS, and the like, can also be retrieved from various data sources if determined to be relevant to the identified social trend.

Additionally, the publication pitch engine 105 can generate one or more publication pitches with the relevant content by either associating a retrieved media portion with a corresponding retrieved content portion or, in some instances, super-imposing the corresponding content portion on top of the retrieved media portion. Each generated content pitch can be provided to the user device 106 for display via the UI component 108. The publication pitch may be presented using any number of user interfaces that allow a user to explore the generated pitch. The UI component 108 can be the same UI component utilized by the social data analytics engine 104.

In some further embodiments, the publication pitches generated by the publication pitch engine 105 can include media portions, content portions, or combinations thereof, retrieved from any source that is not necessarily limited by a competitor asset, but still relevant to and in accordance with the identified social trend. Sources can include other social networks, news assets (e.g., websites, social sites, forums, etc.), search engines, blogs, wikis, and other electronic information sources. In other words, once a particular trend is identified or selected, relevant content can be obtained and presented to a user to facilitate content ideation, in accordance with embodiments described herein. By way of example, if a user selects “home improvement” as an identified trend, the publication pitch engine 105 can employ the UI component 108 to present the user with one or more publication pitches, which can include generated posts, multimedia (e.g., images, videos, animations), articles, URLs, hashtags, taglines, quotes, and any other electronic content that can be electronically shared over a network.

In some configurations, the user may employ the UI component 108 to select a particular identified social trend for generating one or more publication pitches. As shown in FIG. 1, information regarding a user-selected social trend may be received by the publication pitch engine 105 via a user input module 140. The information may include the selected social trend, the categories, terms, keywords, time period, lifespan, other metadata associated with the selected social trend, or any combination thereof. By allowing the user to specify a particular social trend, the publication pitch engine 105 can generate publication pitches for that social trend. For instance, a user may wish to generate a publication pitch for a low-ranked social trend identified within the pieces of social data.

While the publication pitch engine 105 is shown separate from the user device 106, it should be understood that the publication pitch engine 105 may be provided on the user device 106 in some configurations or the publication pitch engine 105 may be provided remote from the user device 106 in other configurations (e.g., provided on a remote server). If the publication pitch engine 105 is remote from the user device 106, the publication pitch engine 105 and user device 106 communicate over a network (not shown), which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present invention. Each may comprise a single device or multiple devices cooperating in a distributed environment. For instance, the publication pitch engine 105 may be provided via multiple devices arranged in a distributed environment that collectively provide the functionality described herein. Additionally, other components not shown may also be included within the system 100.

The publication pitch engine 105 can include a number of modules that process information regarding particular social trends 124, associated keywords 126, trend lifespans 128, or any combination thereof, to retrieve relevant content and generate publication pitches in accordance with particular social trends, including a content collection module 142 and a pitch generation module 144. In some configurations, machine learning processes can be employed to process the information regarding the particular social trends to retrieve and generate the same.

The content collection module 142 can obtain electronic content, which may include at least one of a media portion or a content portion, that is relevant to a particular identified social trend. The content collection module 142 can process a content query that is based on the identified social trend and generated by the publication pitch engine 105 to determine appropriate search parameters, and execute searches on one or more data sources 150a-150c to retrieve relevant content in accordance with the social trend. The publication pitch engine 105 can be in communication with the data sources 150a-150c directly or over a network (not shown), as previously described. The data sources 150a-150c can include licensed content or unlicensed content (e.g., watermarked images or video) that can be utilized to generate a publication pitch. In some configurations, the content query can be communicated to the data source and processed thereon, such that relevant content is retrieved in response to sending the content query to the data source. In either configuration, processing of a content query can be interpreted as any portion of the process of retrieving relevant content based on the content query provided by the publication pitch engine 105.

The pitch generation module 144 can generate one or more publication pitches that are each based on the identified social trend. In other words, the pitch generation module 144 can generate one or more example pieces of social content that a media portion, a content portion, or a combination thereof, and further correspond to a particular social trend identified by the social data analytics engine 104 in accordance with embodiments described herein. In this way, trends-based social content ideation can be facilitated by various components of the system described in FIG. 1.

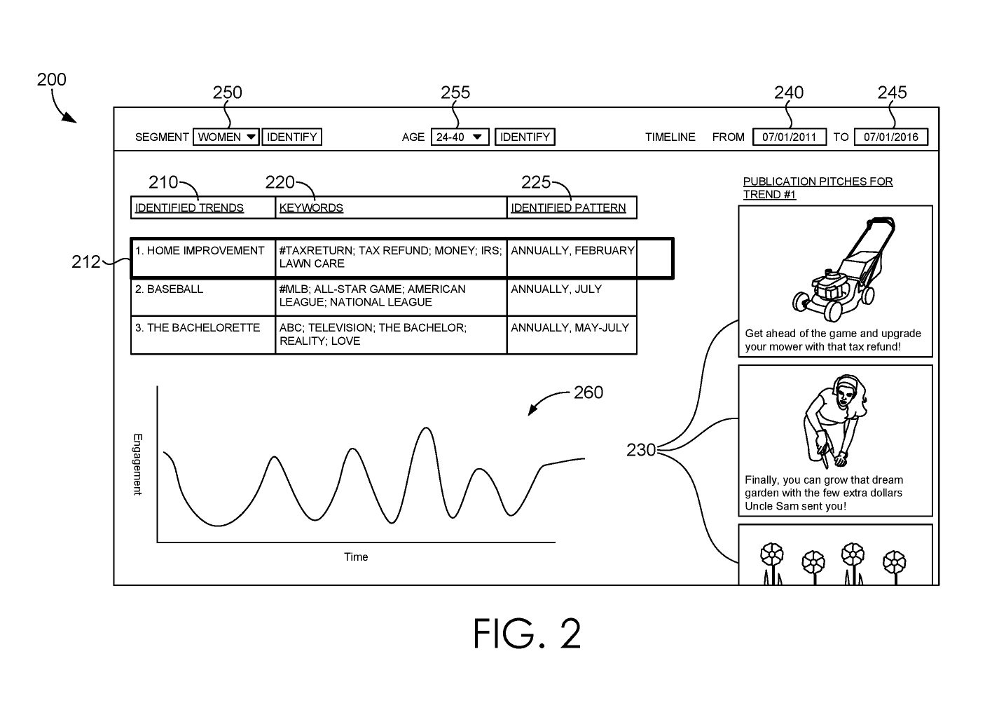

FIG. 2 provides a screenshot illustrating an example user interface 200 that provides an indication of popular social trends 210 identified within pieces of social data, important keywords 220 associated with each identified trend, and temporal patterns associated with each identified trend. The user interface 200 also includes example publication pitches 230 that are based on a selected social trend 212 among the identified social trends 210. In embodiments, a user could employ temporal factor fields 240, 245 to modify the time period being analyzed. A user could further employ the visitor segment selectors 250, 255 to modify the visitor segment being analyzed.

The relative popularity of a selected trend for the selected visitor segment and time period is shown by a trend visualizer 260. The ranking of the identified social trends 210 in the present example is as follows: Home Improvement, Baseball, and the Bachelorette. The identified social trends 210 and/or their rankings would be different for other visitor segments reflecting different interests among varying audiences, and for other time segments. The relative popularity of the other social trends to the pieces of social data may be represented in the trend visualizer 260, for instance, by using different coloring, cross-hatching, or other visual indicators.

With each identified social trend are keywords 220 that are popular to this visitor segment. For example, within the “Home Improvement” social trend, popular keywords 416 for the current visitor segment include: “#TAXRETURN”, “TAX REFUND”, “MONEY”, “IRS”, and “LAWN CARE.” The order of the keywords 220 shown for each identified trend 210 can represent the relevance/popularity of that keyword for the selected visitor segment.

Based on a selected trend 212, which can be determined based on a received user input such as a mouse click or touch input, the user interface 200 can be updated with a visual representation of one or more social trends identified in at least a portion of the social data. For example, trend visualizer 260 shows a histogram of consumer engagement with pieces of social content meeting not only the selected visitor segment and temporal segment, but also those that correspond to the selected trend 212. Here, the histogram illustrates rates of consumer engagement with pieces of social content over the defined time period.

In addition, and also based on a selected trend 212, the user interface 200 can be updated with one or more publication pitches 230 that are generated for user review, among other things. Each publication pitch 230 can include a media portion and a content portion that are relevant to the selected trend 212. In some embodiments, a particular publication pitch 230 can be selected for publication to a social network. That is, a user can determine that a particular publication pitch 230 is suitable for publication to a social network and thus decide to select the particular publication pitch 230 for publication. In this regard, it is contemplated that a user can select, or even modify, a particular publication pitch 230, for publication to a social network. It is further contemplated that one or more social networks can be selected by the user, such that the selected publication pitch 230 is formatted to accommodate publication formats as required by the social network.

The foregoing examples are intended to be non-limiting and merely examples of many potential embodiments covered by embodiments described herein. It is contemplated that various implementations can be utilized to represent any of the data, variations of the data, or arrangements of the data, as illustrated in FIG. 2. It is further contemplated that different characteristics of social trends can be determined and provided for display in a variety of configurations.

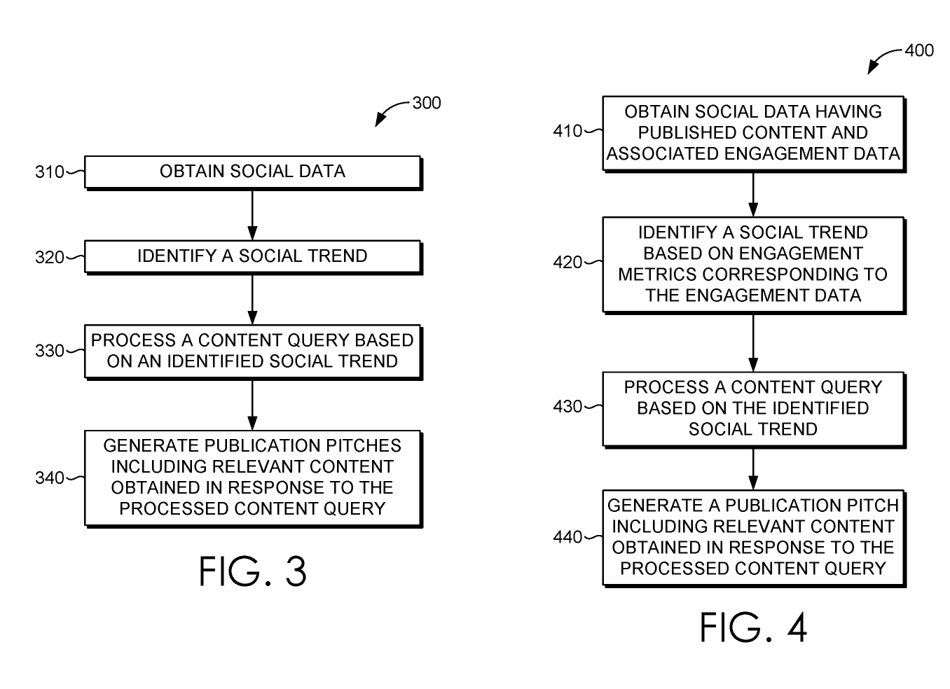

Having described various aspects of the present disclosure, exemplary methods are described below for automating social content ideation based on identified social trends. Referring to FIG. 3 in light of FIGS. 1-2, FIG. 3 is a flow diagram showing a method 300 for enabling computer-implemented social content ideation. Each block of method 300 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

At block 310, social data, for instance social data 102 of FIG. 1, is obtained from one or more competitor assets. Social data can be obtained from each competitor asset, and may include one or more social “posts” or pieces of social content, each of which can include a media portion, a content portion, an engagement portion having engagement data, or any combination thereof. In accordance with embodiments described herein a competitor asset can include any one of a social media feed, a social media page, a webpage, a landing page, a blog, an electronic form, or any publically-accessible electronic medium that can provide for consumer interaction with social content published thereon. By way of example only, the social data analytics engine 104 can obtain the social data by retrieving it directly from the competitor asset(s), receiving it as one or more data files, receiving it from a database, or receiving it as raw data, among other methods.

At block 320, one or more social trends are identified, by the social data analytics engine 104 of FIG. 1 for instance, based on the obtained social data associated with the competitor asset(s). A social trend can be identified by analyzing engagement metrics generated in accordance with the engagement data associated with the obtained social data. That is, popular posts, keywords, topics, and the like, can be determined utilizing machine learning techniques, statistical analysis, or any combination thereof. In one example, a social trend can be identified based on relative popularity as indicated by engagement data associated with each piece of social data. In some embodiments, a trending score can be determined for each identified trend, where each trending score is based on a popularity of the associated trend when compared to other identified trends on the competitor asset and/or other competitor assets. In another example, information in the engagement data can be analyzed to identify patterns in the obtained social data, such as periodically recurring themes, for instance.

The engagement metrics for the social data can include categories, topics, subjects, keywords, terms, phrases, sentences, hashtags, and other contextual information, along with associated numerical metrics data that can be utilized to identify social trends in the social data. It is contemplated that a variety of pattern identification techniques and statistical analyses is employed to determine the metrics.

It is further contemplated that various machine learning processes can be employed to determine the engagement metrics and to further identify the social trends based thereon. Machine learning processes can, in some embodiments, be employed to determine a short phrase or key terms to better characterize an identified social trend. For instance, if an identified social trend comprised of an odd combination of key terms, such as “house” and “fix”, the term “home improvement” may be determined to better characterize the identified social trend and thus be utilized to identify the social trend.

At block 330, a content query is generated, by the content collection module 142 of FIG. 1 for instance, based on the identified social trend, among other things, and processed by one or more processors to obtain content that is relevant to the identified social trend. The content query can include search terms that include the identified social trend, associated categories, topics, terms, keywords, time periods, visitor segments, and the like.

The content query can also include search-modifiers, such as Boolean operators, that can modify the scope of the search for relevant content. The search-modifiers can be determined from user inputs (for instance, via user interface 200) directed to particular keywords, either selected or input, or can be determined from keywords/terms that are determined not to be relevant but recurring in a portion of the pieces of social content corresponding to an identified trend. It is contemplated that various machine learning techniques can be employed to identify such keywords and terms in this regard.

In some embodiments, processing the content query can send the search terms to one or more data sources configured to process a search thereon and return relevant content in response to receiving the search terms. The data sources can be remote, such that communications therewith are performed over a network. The data sources can also be local or removable, such that data can be transferred over a hard wire. The data sources can store a variety of electronic information that can be utilized as a media portion and/or a content portion for generating social content. It is contemplated that each piece of electronic information can include searchable metadata, tags, categories, folders, or content, to facilitate identification of its relevance to the content query being processed.

At block 340, one or more publication pitches can be generated, for instance, by the pitch generation module 144 of FIG. 1. A publication pitch can include one or more pieces of relevant content that are based on an identified social trend. That is, embodiments described herein can generate a piece of social content that can be published on one or more social networks, where the generated piece of social content is based on a social trend identified from a competitor asset. The generated publication pitch can include one or more pieces of relevant content obtained as a result of the processed content query, and can include one or more media portions and/or one or more content portions. It is contemplated that each publication pitch can be generated for one or more particular social networks, in that the publication pitch is formatted for optimal viewing on the one or more particular social networks. It is further contemplated that a user can selectively determine which social network format is to be utilized for generation of publication pitches. In some embodiments, the user can selectively determine which one or more publication pitches are suitable for publication, and effectively push or publish the selected publication pitches to their respective social networks. In further embodiments, the user can selectively determine a date and/or time to publish a particular publication pitch, such that the publication pitch is published at an appropriate time in accordance with the identified trend.

Referring now to FIG. 4 in light of FIGS. 1-2, FIG. 4 is a flow diagram showing a method 400 for enabling computer-implemented social content ideation. Each block of method 400 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

At block 410, pieces of social data, for instance pieces of social data 102 of FIG. 1, that are associated with one or more competitor assets are obtained. Each obtained piece of social data can include pieces of published content and/or associated engagement data. As described herein, engagement data can include comments, opinions, “likes”, “dislikes”, “tweets”, “retweets”, hashtags, usernames, user references, emoticons, ASCII art, images, animations, videos, audio, text, URLs, any other electronic media that can be publicly shared on a network and associated with a piece of social content, or any combination thereof.

At block 420, a social trend is identified from the obtained pieces of social data, for instance, by social data analytics engine 104 of FIG. 1. The social trend can be identified based on an analysis of engagement metrics that are extracted from engagement data associated with the obtained pieces of social data. Each identified social trend can reference one or more relevant keywords that correspond to at least some of the pieces of social data. That is, a determination can be made that one or more social posts correspond to an identified trend, and many if not all of the posts may include certain recurring keywords that can be determined as relevant because they are present in many or all of the social posts.

At block 430, a content query is generated based on the identified social trend, among other things, and processed by one or more processors to obtain content that is relevant to the identified social trend. The content collection module 142 of FIG. 1 can, for instance, generate and/or process the content query. The content query can include search terms that include the identified social trend, associated categories, topics, terms, keywords, time periods, visitor segments, and the like.

The content query can also include search-modifiers, such as Boolean operators, that can modify the scope of the search for relevant content. The search-modifiers can be determined from user inputs (for instance, via user interface 200) directed to particular keywords, either selected or input, or can be determined from keywords/terms that are determined not to be relevant but recurring in a portion of the pieces of social content corresponding to an identified trend. It is contemplated that various machine learning techniques can be employed to identify such keywords and terms in this regard.

In some embodiments, processing the content query can send the search terms to one or more data sources configured to process a search thereon and return relevant content in response to receiving the search terms. The data sources can be remote, such that communications therewith are performed over a network. The data sources can also be local or removable, such that data can be transferred over a hard wire. The data sources can store a variety of electronic information that can be utilized as a media portion and/or a content portion for generating social content. It is contemplated that each piece of electronic information can include searchable metadata, tags, categories, folders, or content, to facilitate identification of its relevance to the content query being processed.

At block 440, one or more publication pitches can be generated, for instance, by the pitch generation module 144 of FIG. 1. Each publication pitch can include at least a portion of relevant content obtained in response to processing the content query. That is, one or more pieces of relevant content obtained can be combined (e.g., stitched, layered, formatted, configured in a layout, etc.) to generate a publication pitch that is based on the identified trend. As was described, it is contemplated that each publication pitch can be generated for one or more particular social networks, such that the publication pitch is formatted for optimal viewing on the one or more particular social networks. It is further contemplated that a user can selectively determine which social network format is to be utilized for generation of publication pitches. In some embodiments, the user can selectively determine which one or more publication pitches are suitable for publication, and effectively push or publish the selected publication pitches to their respective social networks. In further embodiments, the user can selectively determine a date and/or time to publish a particular publication pitch, such that the publication pitch is published at an appropriate time in accordance with the identified trend.

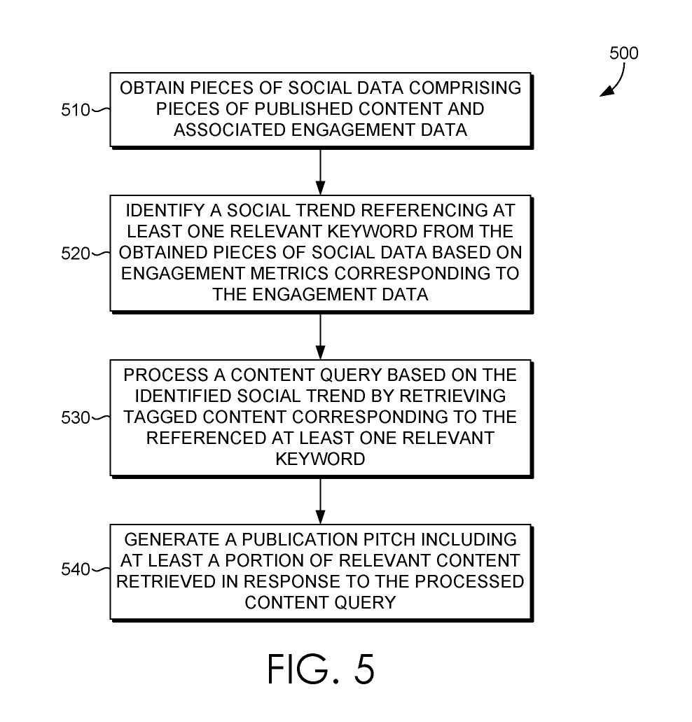

Referring now to FIG. 5 in light of FIGS. 1-2, FIG. 5 is a flow diagram showing a method 500 for enabling computer-implemented social content ideation. Each block of method 500 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

At block 510, one or more pieces of social data, such as the pieces of social data 102 of FIG. 1, that are associated with one or more competitor assets are obtained. Each of the obtained pieces of data can include pieces of published content and associated engagement data.

At block 520, a social trend can be identified from the obtained pieces of social data, for instance, by social data analytics engine 104 of FIG. 1. That is, engagement metrics extracted from the obtained pieces of social data can be analyzed to identify one or more social trends. Each identified social trend can reference one or more keywords that are relevant to the identified trend, and can be recited by or correspond to one or more of the pieces of published content.

At block 530, a content query that is based on the identified social trend can be processed, for instance, by content collection module 142 of FIG. 1. Processing of the content query results in a retrieval of tagged content from one or more data sources, where the tagged content includes references that correspond to the one or more keywords referenced by the identified trend.

At block 540, a publication pitch including at least portion of relevant content retrieved in response to the processing of the content query can be generated, for instance, by pitch generation module 144 of FIG. 1. The generated publication pitch is based on the identified social trend, so that the user can view the publication pitch and, in some embodiments, queue the publication pitch for publication in accordance with the identified social trend.

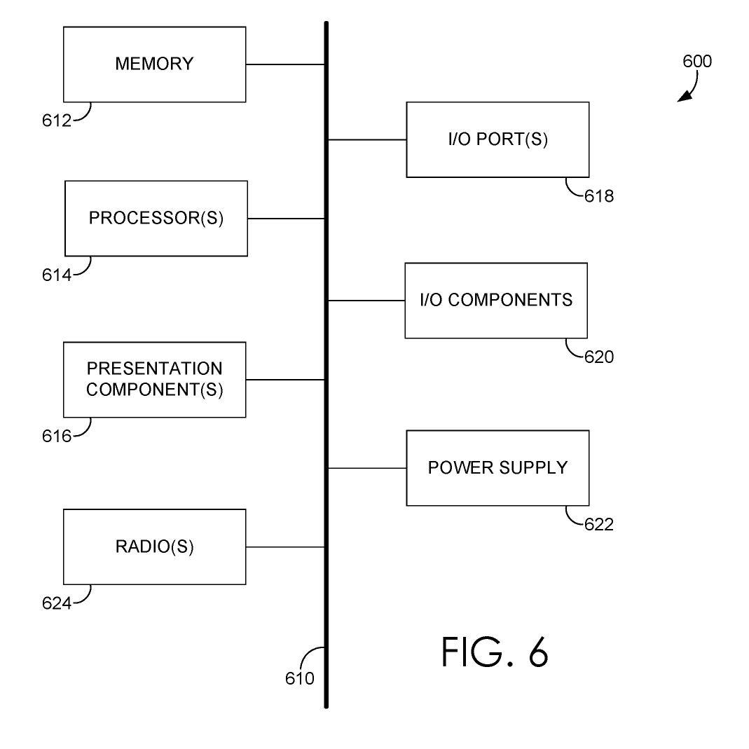

Having described implementations of the present disclosure, an exemplary operating environment in which embodiments of the present invention may be implemented is described below in order to provide a general context for various aspects of the present disclosure. Referring initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes bus 610 that directly or indirectly couples the following devices: memory 612, one or more processors 66, one or more presentation components 616, input/output (I/O) ports 618, input/output components 620, and illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules or other data in a modulated data signal such as a carrier wave or other transport mechanism and includes any information delivery media. The keyword “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer-storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 600. The computing device 600 may be equipped with depth cameras, such as, stereoscopic camera systems, infrared camera systems, RGB camera systems, and combinations of these for gesture detection and recognition. Additionally, the computing device 600 may be equipped with accelerometers or gyroscopes that enable detection of motion.

As described above, implementations of the present disclosure relate to techniques for enabling trends-based social content ideation. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A computer-implemented method for optimizing social content ideation, the method comprising:
obtaining, by a computing device, pieces of social data associated with at least one competitor asset;
identifying, by the computing device, a social trend based on the obtained pieces of social data associated with the at least one competitor asset;
processing, by the computing device, a content query that is generated based at least in part on the identified social trend, wherein relevant content is obtained from at least one content data store in communication with the computing device when the content query is processed; and
generating, by the computing device, at least one publication pitch for presentation as at least one potential social post, each generated publication pitch including at least a portion of relevant content obtained in response to the processed content query and being based on the social trend identified from the obtained pieces of social data associated with the at least one competitor asset.

2. The method of claim 1, the competitor asset comprising one of a social media feed, a social media page, a webpage, a landing page, a blog, and an electronic forum.

3. The method of claim 1, the obtained pieces of social data comprising pieces of published content and engagement data associated therewith.

4. The method of claim 3, the social trend being identified by at least analyzing engagement metrics based on the engagement data and obtaining at least one relevant keyword associated with at least a portion of the pieces of published content.

5. The method of claim 4, the content query being generated based at least in part on the obtained at least one relevant keyword associated with at least a particular portion of the pieces of published content.

6. The method of claim 4, further comprising:
obtaining, by the computing device, relevant content in response to the processed content query, the relevant content being obtained by retrieving tagged content based on the obtained at least one relevant keyword associated with at least a particular portion of the pieces of published content.

7. The method of claim 1, further comprising:
associating, by the computing device, a trending score with the identified social trend, the trending score being based on a popularity of the identified social trend among a plurality of competitor assets.

8. The method of claim 1, further comprising:
providing for display, by the computing device, the generated at least one publication pitch including the relevant content obtained in response to the processed content query.

9. The method of claim 1, further comprising:
publishing, by the computing device, at least a portion of a selected publication pitch to a social network.

10. A non-transitory computer storage medium storing computer-useable instructions that, when used by one or more computing devices, cause the one or more computing devices to perform operations comprising:
obtaining pieces of social data associated with at least one competitor asset, the obtained pieces of social data comprising pieces of published content and engagement data associated therewith;
identifying a social trend from the obtained pieces of social data based on engagement metrics that correspond to the engagement data, the identified social trend referencing at least one relevant keyword that corresponds to at least a portion of the pieces of published content;
processing a content query that is based on the identified social trend; and
generating a publication pitch for presentation as a potential social post, the publication pitch including at least a portion of relevant content obtained in response to the processed content query and being based on the social trend identified from the obtained pieces of social data associated with the at least one competitor asset.

11. The medium of claim 10, the operations further comprising:
publishing the generated publication pitch to a social network in accordance with the identified social trend.

12. The medium of claim 10, wherein the at least one relevant keyword is obtained by employing machine learning processes that summarize at least the portion of the pieces of published content into the at least one relevant keyword.

13. The medium of claim 10, wherein the engagement metrics indicate a popularity of each piece of published content in the obtained pieces of social data, the popularity of each piece being based on engagement data.

14. The medium of claim 10, the operations further comprising:
obtaining relevant content in response to the processed content query, the relevant content being obtained by retrieving tagged content based on the obtained at least one relevant keyword.

15. The medium of claim 10, wherein the social trend is identified from the obtained pieces of social data based further on a temporal factor.

16. A computerized system comprising:
one or more processors; and
one or more computer storage media storing computer-usable instructions that, when used by the one or more processors, cause the one or more processors to:
obtain pieces of social data associated with at least one competitor asset, the obtained pieces of social data comprising pieces of published content and engagement data associated therewith;
identify a social trend from the obtained pieces of social data based on engagement metrics that correspond to the engagement data, the identified social trend referencing at least one relevant keyword that corresponds to at least a portion of the pieces of published content;
process a content query that is based on the identified social trend by retrieving tagged content corresponding to the referenced at least one relevant keyword; and
generate a publication pitch including at least a portion of relevant content retrieved in response to the processed content query, the generated publication pitch being based on the social trend identified from the obtained pieces of social data associated with the at least one competitor asset.

17. The system of claim 16, wherein the generated publication pitch is formatted for publication on at least one social network.

18. The system of claim 16, the one or more computer storage media storing computer-usable instructions that, when used by the one or more processors, further cause the one or more processors to:
retrieve tagged content corresponding to the referenced at least one relevant keyword from at least one data store.

19. The system of claim 16, wherein the engagement metrics include at least one of an annual trend, a seasonal trend, a monthly trend, a weekly trend, and a daily trend.

20. The system of claim 16, wherein the pieces of social data associated with at least one competitor asset are obtained in response to a social data query.
